(19) United States
(12) Patent Application Publication
(10) Pub. No.: US 2022/0194124 A1
(43) Pub. Date: Jun. 23, 2022

(54) BEAM AXLE

(71) Applicant: Schaeffler Technologies AG & Co. KG, Herzogenaurach (DE)

(72) Inventor: Tuo Luo, Copley, OH (US)

(73) Assignee: Schaeffler Technologies AG & Co. KG, Herzogenaurach (DE)

(21) Appl. No.: 17/518,702

(22) Filed: Nov. 4, 2021

Related U.S. Application Data
(60) Provisional application No. 63/127,549, filed on Dec. 18, 2020.

(51) Int. Cl. B60B 35/16

(52) U.S. Cl. CPC B60B 35/16; B60K 2001/001

(57) ABSTRACT

An electric beam axle has a central housing around the electric motor and the differential gearing. Tubes are attached to each side of the central housing around the axle shafts. The tubes are attached to the central housing using butt welds. A portion of the central housing near the weld is designed to minimize stress concentrations. In particular, the region immediately adjacent to the weld has a constant thickness. Between the constant thickness region and the main part of the central housing is a tapered region.

### CROSS-REFERENCE TO RELATED APPLICATIONS

This application claims priority to U.S. Provisional Application 63/127,549 filed Dec. 18, 2020, the entire disclosure of which is incorporated by reference herein.

### TECHNICAL FIELD

The disclosure concerns a beam axle. More particularly, the disclosure pertains to an beam axle having tubes butt welded to a central housing.

### BACKGROUND

FIG. 1 shows an electric beam axle 10. An electric motor 12 drives two wheel shafts 14 and 16 via differential gearing 18. The differential gearing divides the torque generated by the electric motor between the shafts 14 and 16 while permitting slight speed differences. Speed reduction gearing may be present between the electric motor and the differential gearing. The wheels shafts are adapted at 20 and 22 to drive respective vehicle wheels.

The electric motor 12 and the differential gearing 18 are retained in a housing 24. The housing includes two central sections 26 and 28 that are bolted to one another and also bolted to two end pieces 30 and 32. Tubes 34 and 36 are rigidly attached to end pieces 30 and 32 respectively. Tubes 34 and 36 includes mounting points 38 and 40 respectively.

A solid axle is designed to be suspended from the vehicle and to maintain the wheel shafts colinear with one another in operation. This is in contrast to an independent suspension in which the central housing is rigidly attached to the vehicle and half-shafts extend to the wheels at angles which vary as the wheel position relative to the vehicle frame fluctuates. Whereas mechanical axles receive power via a rotating driveshaft, and electric axle receives power via current-carrying wires.

FIG. 2 shows the connection of central section 26, end piece 30, and tube 34. Note that tube 34 extends into end-piece 30. A weld 42 joins tube 34 to end-piece 30. Bolts 44 connect end-piece 30 to central section 26. The weld 42 connects an axial end surface of end-piece 30 to a radially outer surface of the tube 34.

### SUMMARY

A beam axle includes first and second wheel shafts, a housing, and a first tube. The first and second wheel shafts are configured to drive first and second wheels respectively. The housing has a first circular opening, a first region having a first thickness adjacent to the first circular opening, a first tapered neck having a thickness that increases with increasing distance from the first circular opening, and a first tube side chamfer connecting the first region to the first tapered neck. The first tube surrounds the first wheel shaft and has a first end butt welded to the first region. The first tapered neck may be integrally formed with a central region of the housing. Alternatively, the first tapered neck may be bolted to the central region of the housing, in which case it may be fabricated from a different material than the central housing. The central region may surround differential gearing driving the first and second wheel shafts and/or an electric motor. The first region may have a chamfered edge at the first circular opening and the first tube may have a chamfered edge at the first end such that the chamfered edges form a V-shaped groove in which the butt weld is formed. An angle between the chamfered edges may be between 60 and 75 degrees. The housing may have a second circular opening on an opposite end of the housing from the first circular opening. A second region having a second thickness may be adjacent to the second circular opening. A second tapered neck may have a thickness that increases with increasing distance from the second circular opening. A second tube side chamfer may connect the second region to the second tapered neck. A second tube may surround the second wheel shaft and have a second end butt welded to the second region.

A beam axle housing defines, at opposite ends, first and second circular openings. The beam axle includes first and second regions, first and second tapered necks, and first and second side chamfers. The first region has a first thickness adjacent to the first circular opening. The first tapered neck has a thickness that increases with increasing distance from the first circular opening. The first tube side chamfer connects the first region to the first tapered neck. The second region has a second thickness adjacent to the second circular opening. The second tapered neck has a thickness that increases with increasing distance from the second circular opening. The second tube side chamfer connects the second region to the second tapered neck. The first tapered neck may be integrally formed with a central region of the housing or may be bolted to a central region of the housing. If bolted, the first tapered neck may be fabricated from a different material than the central housing. The first and second regions may have chamfered edges at the first and second circular openings respectively. An angle of the chamfered edges may be between 30 and 37.5 degrees from a plane perpendicular to an axis extending through the first and second circular openings.

A method of manufacturing a beam axle includes fabricating a housing, butt welding a first tube to the housing, and inserting a first wheel shaft through the first tube. The housing has a first circular opening, a first region having a first thickness adjacent to the first circular opening, a first tapered neck having a thickness that increases with increasing distance from the first circular opening, and a first tube side chamfer connecting the first region to the first tapered neck. The first tube is butt welded to the first region. The first wheel shaft is configured to drive a first wheel. The first region may have a chamfered edge at the first circular opening and the first tube may have a chamfered edge. These chamfered edges may form a V-shaped groove in which the butt weld is formed. An angle between the chamfered edges may be between 60 and 75 degrees.

### BRIEF DESCRIPTION OF THE DRAWINGS

FIG. 1 is a cross-sectional view of a prior art electric beam axle.

FIG. 2 is a detailed view of the connection between the central housing and the tube of the axle of FIG. 1.

FIG. 3 is a detailed view of a butt-weld connection between an axle housing and a tube.

FIG. 4 is a detail view of the connection of FIG. 3.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

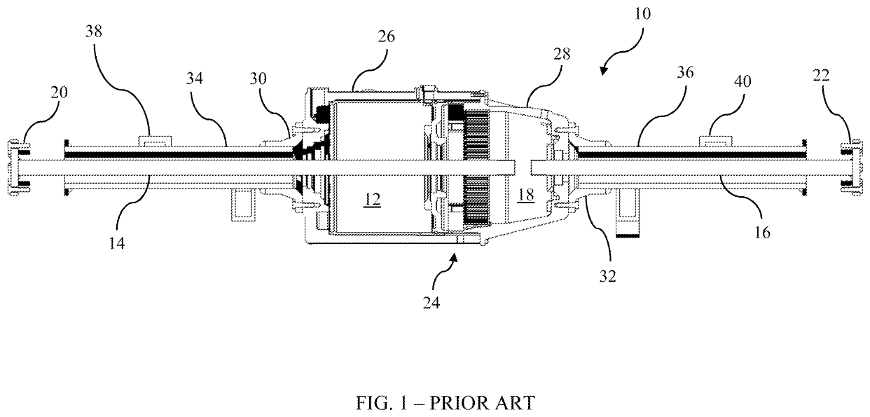

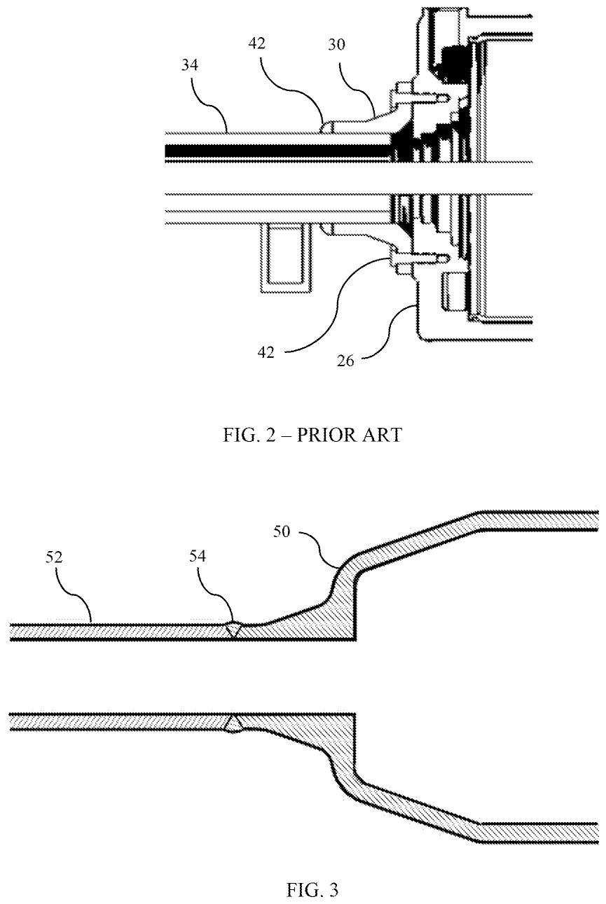

In the axle of FIGS. 1 and 2, the diameter of the assembly changes at the weld. This change in diameter tends to create stress concentrations. High stresses in this region lead to fatigue and may eventually lead to premature failure.

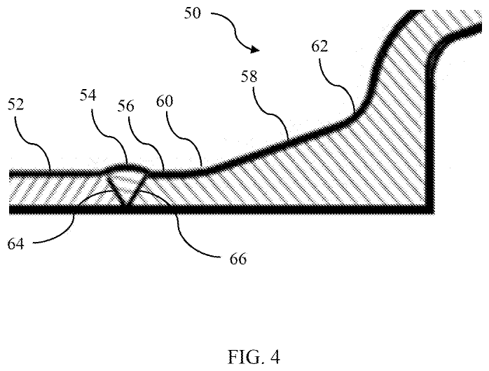

FIGS. 3 and 4 illustrate a different design for connecting a housing 50 and tube 52 which has less peak stress and weighs less. The housing 50 and the tube are connected by a butt weld 54. In other words, the weld connects an axial end surface of housing 50 to an axial end surface of tube 52. Housing 50 includes a constant thickness section 56 adjacent to the butt weld 54 and a tapered section 58 inboard of the constant thickness section. A tube side chamfer 60 forms a smooth transition of the outer surface between the constant thickness section and the tapered section. A flange side chamfer 62 forms a smooth transition from the tapered section to the remainder of the housing 50. Tube 52 and constant thickness section 56 include chamfered surfaces 64 and 66 respectively. These chamfered surfaces form a V-shaped groove around the circumference where the two pieces come together. The butt weld 54 joins these surfaces and fills in this V-shaped groove. For best performance, the angle between the two chamfered surfaces should be between 60 and 75 degrees. In other words, each surface should be angled between 30 degrees and 37.5 degrees from a plane perpendicular to the axis of the tube.

In the embodiment of FIGS. 3 and 4, the tapered section and the constant thickness section are integrally formed with a central section of the housing which contains the motor and or the differential gearing. Alternatively, the tapered section and the constant thickness section may be part of a separate end piece which is bolted to a central section as in the beam axle shown in FIGS. 1 and 2. In such an embodiment, the end-piece may be made of a material that is more suitable for the butt weld and the central section may be made of a different material more suitable for that portion.

The beam axle includes a second tube on the opposite side which is butt welded to a similarly structured housing piece. The housing piece on the opposite side includes a constant thickness section and a tapered section joined by a chamfer as described above. The opposite end may be of integrated construction or separate bolted pieces regardless of which of those types of construction are used on the first end.

In the beam axle of FIGS. 3 and 4, there is no abrupt change in diameter near the butt weld. Therefore, the butt weld minimizes stress concentrations due to diameter change. This permits a lighter assembly with lower peak stress levels that is less susceptible to fatigue.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A beam axle comprising:
first and second wheel shafts configured to drive first and second wheels respectively;
a housing having a first circular opening, a first region having a first thickness adjacent to the first circular opening, a first tapered neck having a thickness that increases with increasing distance from the first circular opening, and a first tube side chamfer connecting the first region to the first tapered neck; and
a first tube surrounding the first wheel shaft and having a first end butt welded to the first region.

2. The beam axle of claim 1 wherein the first tapered neck is integrally formed with a central region of the housing, the central region surrounding differential gearing driving the first and second wheel shafts.

3. The beam axle of claim 1 wherein the first tapered neck is integrally formed with a central region of the housing, the central region surrounding an electric motor.

4. The beam axle of claim 1 wherein the first tapered neck is bolted to a central region of the housing.

5. The beam axle of claim 4 wherein the first tapered neck is fabricated from a different material than the central housing.

6. The beam axle of claim 1 wherein the first region has a chamfered edge at the first circular opening and the first tube has a chamfered edge at the first end, the chamfered edges forming a V-shaped groove, the butt weld formed between the chamfered edges.

7. The beam axle of claim 6 wherein an angle between the chamfered edges is between 60 and 75 degrees.

8. The beam axle of claim 1 wherein the housing has a second circular opening on an opposite end of the housing from the first circular opening, a second region having a second thickness adjacent to the second circular opening, a second tapered neck having a thickness that increases with increasing distance from the second circular opening, and a second tube side chamfer connecting the second region to the second tapered neck.

9. The beam axle of claim 8 further comprising a second tube surrounding the second wheel shaft and having a second end butt welded to the second region.

10. A beam axle housing defining, at opposite ends, first and second circular openings and having:
a first region having a first thickness adjacent to the first circular opening;
a first tapered neck having a thickness that increases with increasing distance from the first circular opening;
a first tube side chamfer connecting the first region to the first tapered neck;
a second region having a second thickness adjacent to the second circular opening;
a second tapered neck having a thickness that increases with increasing distance from the second circular opening; and
a second tube side chamfer connecting the second region to the second tapered neck.

11. The beam axle housing of claim 10 wherein the first tapered neck is integrally formed with a central region of the housing.

12. The beam axle housing of claim 10 wherein the first tapered neck is bolted to a central region of the housing.

13. The beam axle housing of claim 12 wherein the first tapered neck is fabricated from a different material than the central housing.

14. The beam axle housing of claim 10 wherein the first and second regions have chamfered edges at the first and second circular openings respectively.

15. The beam axle housing of claim 14 wherein an angle of the chamfered edges is between 30 and 37.5 degrees from a plane perpendicular to an axis extending through the first and second circular openings.

16. A method of manufacturing a beam axle, the method comprising:
fabricating a housing having a first circular opening, a first region having a first thickness adjacent to the first circular opening, a first tapered neck having a thickness that increases with increasing distance from the first circular opening, and a first tube side chamfer connecting the first region to the first tapered neck;
butt welding a first tube to the first region; and
inserting a first wheel shafts through the first tube, the first wheel shaft configured to drive a first wheel.

17. The method of claim 16 wherein the first region has a chamfered edge at the first circular opening and the first tube has a chamfered edge, the chamfered edges forming a V-shaped groove, the butt weld formed between the chamfered edges.

18. The method of claim 17 wherein an angle between the chamfered edges is between 60 and 75 degrees.
